(19) United States
(12) Patent Application Publication
(10) Pub. No.: US 2021/0081983 A1
(43) Pub. Date: Mar. 18, 2021

(54) Four Actor Binding Agreement System

(71) Applicant: Mathew Robbins, Aurora (CA)

(72) Inventor: Mathew Robbins, Aurora (CA)

(21) Appl. No.: 16/570,407

(22) Filed: Sep. 13, 2019

(51) Int. Cl. G06Q 30/02

(52) U.S. Cl. CPC G06Q 30/0236; G06Q 30/0225; G06Q 30/0222; G06Q 30/0239

(57) ABSTRACT

Herein is disclosed a system for generating, distributing and redeeming electronic coupons. The coupons are for goods and/or services offered to users by promoters on behalf of affiliated retailers. The system includes a coupon application running on a server which is operatively coupled to a mobile application loaded on mobile computing devices held by the users, promoters and retailers. The mobile application is configured to record details of promotion agreements for the creation, distribution and redemption of electronic coupons and forward said details to the coupon application. The mobile application is configured to display a unique identifier codes for each coupon when a user is in physical proximity to the retail location associated with the coupon and permit the retailer to redeem the coupon by scanning the displayed unique identifier code.

### CROSS REFERENCE TO RELATED APPLICATION

This application claims priority from U.S. Provisional Application Ser. No 62/731,856 dated Sep. 15, 2018, the entirety of which is incorporated herein by reference.

### FIELD OF THE INVENTION

The invention relates generally to systems for people referring clients to businesses which ensures that a referral fee is paid to the referrer.

### DISCLOSURE OF THE INVENTION

The present invention is a system for generating promotional coupons by a plurality of promoters for the purposes of promoting a plurality of retailers each operating a retail location and for redeeming said coupons when the retail locations are visited by users wishing to redeem said coupons. The system includes a first and second application running on a server, the first application configured to receive content from the promoters and distribute that content to the users, the second application configured to record details of promotion agreements entered into between the promoters and the retailers and for generating coupons pursuant to the details of the promotion agreements. The coupons each have a unique identifier code generated by the second application. Each of the promoters, retailers and users having a mobile computing device running a mobile application operatively coupled to the first and second applications running on the server via a wireless network, the mobile application configured to record details of the promotion agreements and forward same to the second application. The mobile application is further configured to display the generated unique identifier code for the coupon on the user's mobile application only when the user is within a predefined geographic radius of the retail location associated with the coupon. The retailer's mobile application is further configured to permit the retailer to scan the unique identifier code on the user's mobile application to record the redemption of the associated coupon and upload the scanned unique identifier code to the second application on the server. The second application is configured to record the scanned unique identifier code and match it to the generated unique identifier code generated for the corresponding coupon and record the redemption of the corresponding coupon when the generated and scanned unique identifier codes match. Finally, the second application has a payment module configured to send a monetary payment to the promoter from the retailer when the redemption of the coupon is recorded, the amount of the monetary payment being set by the details of the promotion agreement corresponding to the coupon.

### DESCRIPTION OF THE DRAWINGS

FIG. 1 is a perspective view of a system made in accordance with one aspect of the present invention.

In the drawings like characters of reference indicate corresponding parts in the different figures.

### DETAILED DESCRIPTION OF THE INVENTION

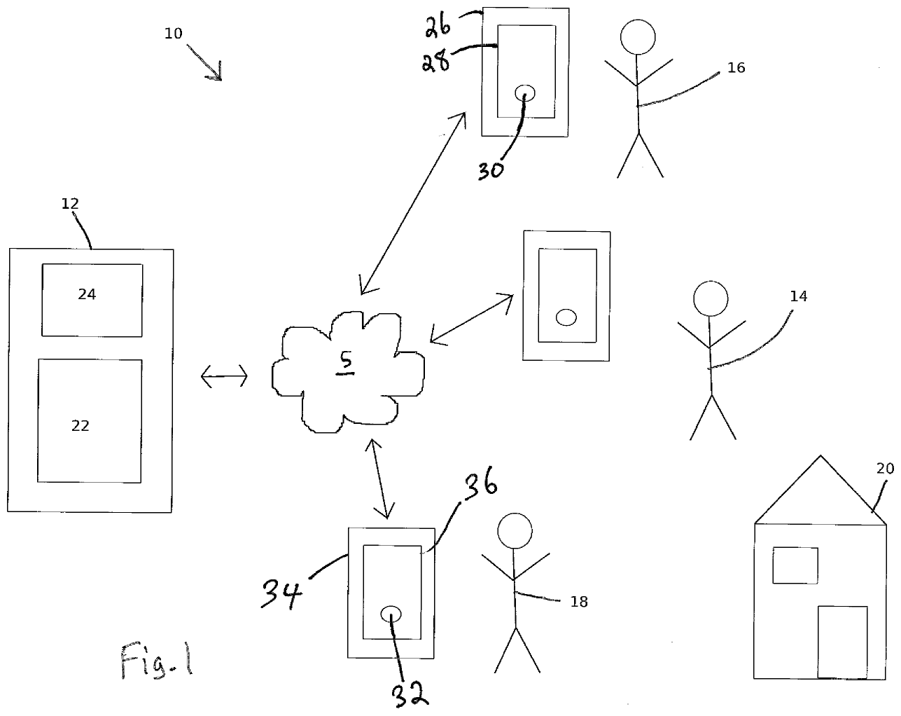

Referring to FIG. 1, the system of the present invention, shown generally as 10, consists of a remote server 12 which can be accessed by three groups of people by way of a computing device, preferably a portable computing device such as a web enabled smart phone or similar device. The users are divided into three groups, namely affiliates (retailers) 14, ambassadors (promoters) 16 and users 18. Affiliates are people (retailers) who operate physical retail location(s) 20 in a particular geographic area, such as a store, a stand, a food truck, a restaurant, a chain of retail stores, a gym, a theater, or any other physical space which is open to the public and which sells goods or services to customers. Ambassadors are people (promoters) who create a deal catered to individuals (users) who are looking for goods or services similar to the ones provided by the affiliate. The ambassadors are essentially charged with the task of promoting the retail businesses of the affiliates. It will be appreciated that the invention is intended to be applicable to a plurality of different marketing channels where the ambassador essentially promotes the products and services offered by affiliate to the users. The ambassador can use a variety of promotional vehicles such as a plurality of websites, social media channels, or the like. The present invention is intended to be incorporated with any of these marketing channels. One such marketing channel is the creation and promotion of walking or cycling tours in a particular geographic area, such as a neighborhood, a retail district, a park, an attraction or any geographic location which contains a plurality of different venues, stores, museums, theaters, or other points of interest which people might wish to visit, hereafter collectively called tour attractions. For the purposes of this application, the present invention shall be described with reference to the marketing channel consisting of a tour. The users in that marketing channel would be people who are interested in attending one or more tours promoted by the ambassador. Ambassador 16 has access to a remote server 12 where details of the tours being promoted by the ambassador are stored and available for review. Users can access server 12 with the intention of finding a suitable tour experience and attending same. It will be appreciated that if the marketing channel was something other than a tour operating and promoting vehicle, for example a video entertainment channel hosted online, the ambassador would provide compelling and popular content hosted on a remote server which can be accessed by users. The content which is desired by individual users may be hosted on server 12 or on a separate server. Server 12 hosts the principle application embodying the processes of the invention, namely application 22. Application 12 is essentially a large database which has been programmed to store, process and serve up information in accordance with the process of the present invention. In the present example, server 12 also hosts the content which the users which to access, referenced as application 24. It will be appreciated that applications 22 and 24 can be hosted on different servers. For example, in the case of an online video entertainment channel, content 24 could be hosted on a separate video server service such as Vimeo™ or Youtube™. Again, for the purposes of this disclosure, the marketing channel will be that of a series of tour experiences (content 24) hosted on remote server 12.

The tours experiences each consist of a description of the geographic location of the tour, a description of the tour attractions, and other information outlining the features and history of the geographic location and the tour attractions contained therein. The description is stored on server 12 and cross referenced under a plurality of headings to make discovering and reading the tour experience. The description can include written text, photographs, images, videos, sound recordings and other media as may be required to better communicate the features of the tour experience. It will be appreciated that each tour experience may have a plurality of physical retail locations operated by a plurality of different affiliates. It will also be appreciated that server 12 will contain a plurality of different tour experiences posted and maintained by a plurality of different ambassadors. Finally, it will be appreciated that a plurality of different users can access server 12 looking for different tour experiences. Each of the ambassadors, affiliates and users preferably carries a portable computing device (smart phone) running a particular application (hereafter called “the application”) which is configured to remotely couple with the server to access, search, modify and download information stored thereon. The application is preferably identical for each of the users, affiliates and ambassadors varying only in the features of the application which are accessible to each by virtue of that person's privileges with the server.

The principle basis of the present invention is that ambassadors 16 can enter into promotional arrangements (deals) with affiliates 14 to promote the affiliate's businesses to the ambassador's audience which consists of users 18. In the present example, ambassadors 16 create tour experiences which they feel might be of interest to a multitude of users 18 and post these tour experiences on server 12 as content 24. Each ambassador can then promote the tour experience to the best of their abilities by methods known generally in the art such as advertisements and promotions placed within content 24. Furthermore, the ambassadors may engage with affiliates to help promote the affiliate's businesses by means of offering users coupons for products and services sold by the affiliate while at the same time generating a revenue stream from the redemption of these coupons. Users 18 attending a specific tour experience can redeem these coupons at the affiliate locations 20 for benefit, at which point the ambassador receives immediate monetary gain from the redemption of the coupons through payment modules built into application 22. The system and method of the present invention ensures that the coupons are easy to issue, easy to use, easy to redeem and that all the redemption are honest.

The process starts with an ambassador 16 attending a geographic location, noting the attractions contained therein, creating a tour experience, and then uploading the tour experience to application 24 on server 12. Application 24 consists of a large multi-relational database configured to receive, store and deliver up multimedia content. Application 24 is preferably built on a content management system such as Drupal, Joomla, Wordpress or any other full featured content management system. Let us take the example of a tour of the historic Kensington Market area in the city of Toronto, Canada. The ambassador attends at the location and notes the various attractions, galleries, shops, markets, and historically and culturally significant buildings in the area. The ambassador takes several pictures, makes a few short videos, writes a description and then uploads the tour experience to the server under the title “Taste of Kensington”. Ambassador 16 can use his/her mobile computing device (smart phone/tablet) 26 to take the photos, videos, and compose the text. Loaded onto mobile computing device 26 is remote application 28 which is configured to communicate with applications 22 and 24 on server 12 via wireless network 5. Ambassador 16 can create all of the content he/she requires using portable device 26 and application 28 and synchronize the content with application 24. Alternatively, ambassador 16 can use a desktop or laptop computer which is networked to couple to server 12. After the tour experience is uploaded (or even before, depending on the privileges held by the ambassador with server 12), the ambassador approaches affiliate 14 having a retail location 20 located in the Kensington market area in the hopes of negotiating a coupon deal with the affiliate. The coupon deal will include details agreed to between the ambassador and affiliate such as what is being offered for the coupon, when the coupons will be issued, when will the coupons expire, the monetary value of the coupon and the commission that will be paid by the affiliate every time a coupon is redeemed by a user. Mobile application 28 is provided with modules to permit ambassador 16 to record the details of the arrangement agreed to between the ambassador and affiliate 14. In this example, let's assume the affiliate is the operator of a Chilean themed restaurant who sells empanadas and other traditional Chilean food. The ambassador informs the affiliate that she would receive additional business if she offered users attending his “Taste of Kensington” tour experience a free beverage for every large empanada the user purchases. The mobile application is configured to make the negation and recording of the coupon deal easier by providing templates and easy to fill forms for recording the agreement. Both the affiliate and the ambassador have mobile application 28 loaded onto their respective smart phones 26 and use the mobile application to negotiate the terms and record the agreement reached. The mobile application produces screens and templates which guide the ambassador/affiliate in identify the parties to the agreement, the nature of the coupon to be offered (in this case, a free beverage with the purchase of a large empanada), the number of coupons being offered, the expiration date of the coupons and the commission the affiliate is prepared to pay for the privilege of having the ambassador promote the affiliate's retail location on the ambassador's tour experiences. The mobile application is configured to automatically generate forms which helps the parties record the names, dates and specifics of the coupon offer, with the legal terms of the agreement be standardized and automatically generated prior to final approval of the coupon agreement. The ambassador uses the mobile application and the forms it generates to record the details of the coupon agreement. When the details of the agreement are agreed to by the parties, the ambassador executes a generate command on the application by tapping on a screen icon, and the application then generates the coupon agreement, generates a unique QR Code 30 for that specific agreement, and uploads the agreement and corresponding QR Code to application 22 on server 12. The ambassador's mobile device running the mobile application displays the unique QR Code 30 for the coupon agreement, which the affiliate can then scan with her own mobile device running the mobile application. The affiliate's version of the mobile application is adapted and configured to record the details of the coupon agreement, and the act of scanning the unique QR Code 30 by the affiliate acts as acceptance of the corresponding coupon agreement. The affiliate's mobile computing device then uploads the unique QR Code 30 which was scanned to application 22 on server 12 to record the acceptance of the terms of the agreement.

After concluding business with the first affiliate, the ambassador can then explore signing up additional affiliates who's retail locations are located within the tour experience's location. The process of negotiating and recording coupon agreements with the additional affiliates is also done through the application in the same way as discussed above. The application generates a unique QR code for each coupon agreement, which is scanned by the respective affiliate to act as proof of the affiliate's acceptance of the terms of each agreement. Preferably, applications 22 and 24 are configured and coupled to each other such that when an affiliate coupon deal is entered into application 22, the content in application 24 is updated to list the coupon deal in the ambassador's tour experience contained in content 24 which relates to the retail location 20. Alternatively, the ambassador can log into server 12 to update the tour experience to list details of each affiliate and the coupons which are available to users for use with the affiliates. Users looking through the ambassador's tour experiences can view the affiliate's locations and the coupons being offered for redemption there.

Users also have mobile computing device 34 running the mobile application 36. The privileges which the users have with respect to server 12 permit the users to search for and view tour experiences posted by various ambassadors. The users can read the written descriptions of the tours, view the images and watch the videos associated with the tour experiences. The users can also view the details of the coupons associated with the various affiliate locations located at or near the geographic location of the tours. The application is configured to permit the users to quickly call up the coupons for later consideration when the user is in the appropriate retail location. In the event the user goes on the ambassador's tour, the user may stop by an affiliate's location located on the tour experience with the intention of redeeming the coupon. The user's mobile computing device 34 is provided with a GPS feature common to all smart phones and similar portable computing devices. The mobile application running on the user's mobile computing device is configured to accesses the GPS feature of the smart phone to help direct and guide the user through the tour experience. When the application notes that the user is within a short distance of an affiliate's retail location, the application sends a notification to the user pointing out that the retail location he or she is standing near has a coupon associated with it. The application is configured to “activate” the coupon when the application senses that the user is within a short distance from the retail location. The application is configured such that the coupon becomes redeemable only when the user's mobile device is within a predetermined distance (hereafter called the activation radius) of the affiliate's geographic location. For example, the application is configured to “activate” the coupon (i.e. make it possible to redeem the coupon) only when the user's mobile device is within 50 meters of the affiliate location associated with the coupon (i.e. the activation radius is 50 meters). It will be appreciated that the activation radius may be set by the ambassador while negotiating with the affiliate and may be different for different affiliates and different tour experiences. It is also preferable if the application is configured to permit the ambassador to modify the activation radius at a later date.

When user 18 attends the tour experience and is within the activation radius of a particular coupon, the user can choose to select the coupon from the mobile application to reveal the coupon by triggering a redeem function. The mobile application and application 22 are configured to generate a QR code 32 specific for that particular coupon and display that QR code as part of the coupon on the mobile device 34. The mobile application on the user's smart phone then sends a redemption notification to server 12 indicating that the coupon has been tapped and activated for redemption and the specific QR code has been generated for that coupon. The user redeems the coupon by presenting his/her mobile device to the affiliate who then scans the coupon and QR code associated therewith using the mobile application on her mobile computing device. The Affiliate provides the user with the coupon's value, in this case a free beverage when the user purchases a large empanada. The mobile application on the affiliate's mobile device then sends a notification to the server that the coupon associated with the specific QR code has been redeemed. Server 12 is configured to process the commission payable to the ambassador by charging the affiliate's account for the redemption of the coupon. The ambassador is charged a small fee for the use of the server's privileges. The amount of commission charged is set by the coupon agreement stored on the server which was agreed to by the ambassador and the affiliate. In the example illustrated, the affiliate and ambassador agreed to pay a fee of $0.10 for each coupon redeemed. The agreement between the ambassador and the person operating server 12 has been previously agreed to specify that the server operator will deduct the amount of $0.03 for each coupon redemption, so the server credits the ambassador with the net amount of $0.07 for the redemption of the coupon.

The mobile application may be further configured to permit users to leave comments or reviews of the affiliate after the user has activated the coupon associated with the affiliate. The mobile application is configured to display a feedback/review screen on the mobile device in response to the user redemption of the corresponding coupon. The user can then leave a comment, rate the experience of the affiliate's location and include photos for inclusion with the review. The mobile application is configured to allow the user to activate feedback/review feature only after the coupon's QR code is scanned by the affiliate. The user's feedback/review is then uploaded to server 12 when the use activates the “send” feature of the feedback/review screen. The feedback/review created by the user is then incorporated into server 12's databases so that the affiliate, ambassador and other users can access and view the feedback/review. It is important to note that the mobile application is configured such that the feedback/review feature cannot be activated without the user first activating and displaying the coupon for that affiliate and redemption of the coupon.

The present invention is designed to flag coupons which have been presented by users (when the users trigger a redeem function in their mobile applications), but which were not subsequently scanned by an affiliate. (i.e. not “officially” redeemed by the affiliate). For example, an unscrupulous affiliate my choose to honor coupons presented to her by providing the user with the benefit declared on the coupon (a free beverage for example), but not scan the coupon/QR code. This would enable the affiliate to gain the benefit of the additional sale without bearing the commission costs payable to the ambassador and the server operator. The server is configured to flag instances where the server receives notice when the user activates the coupon and presents it for redemption, but the server does not receive a notification from the corresponding affiliate that they have scanned the coupon which was activated. Principally, the user's mobile application is configured to send a redemption notification to the server when the user activates the redeem function for a coupon on the mobile application. The server will have the QR code associated with the coupon for which the redemption notice was sent. The server will then flag the coupon as suspicious in the event the server application does not match the stored QR coded associated with the allegedly redeemed coupon with a scanned QR code received from the affiliate associated with the allegedly redeemed coupon. The server is preferably configured to message the affiliate of the discrepancy and warn the affiliate that their privileges to use the server will be terminated if the affiliate fails to properly redeem the coupons as required. The server is also preferably configured to generate that warning message in the event a coupon is generated and a feedback/review entry is logged in association with that coupon but the coupon was not scanned by the affiliate since this strongly indicates that the affiliate has received the benefit of the coupon without incurring the commission costs associated therewith.

The server database and mobile application are configured to permit the ambassador to easily promote tours to users by linking to various social media tools (Facebook™, Instagram™, Twitter™, YouTube™, etc.). The server database and mobile application are also configured to permit users, ambassadors and affiliates to register with the server to obtain server privileges such as the ability to create tours, view and search for tours, purchase tours, offer affiliate services in exchange for coupons, etc.. The server includes a merchant gateway to permit users to purchase tours, ambassadors to receive commissions and affiliates to pay commissions for redeemed coupons and advertising. Server 12 can be further configured to monetarily reward ambassadors for promoting tour experiences, promoting affiliate businesses and promote the tour experiences of other ambassadors. Server 12 can be further configured to include a social media component such as discussion forums, video and image sharing, chat rooms and the like.

The present invention has many advantages over traditional tour promotion, advertising and organizing systems. Firstly, the system provides for a quick and secure way of negotiating and registering coupon/promotion agreements between promoters (ambassadors) and affiliates. The system also provides a secure way to ensure that affiliates only pay a commission/sales fee for adverting and promotion which has actually generated additional business by ensuring that coupons are not paid for (by commissions) until they are scanned. The system also ensures that fraudulent coupon use is avoided and that coupons can only be redeemed while at or near the affiliate location.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A system for generating promotional coupons by a plurality of promoters for the purposes of promoting a plurality of retailers each operating a retail location and for redeeming said coupons when the retail locations are visited by users wishing to redeem said coupons, the system comprising
a first and second application running on a server, the first application configured to receive content from the promoters and distribute that content to the users, the second application configured to record details of promotion agreements entered into between the promoters and the retailers and for generating coupons pursuant to the details of the promotion agreements, said coupons each having a unique identifier code generated by the second application;
each of the promoters, retailers and users having a mobile computing device running a mobile application operatively coupled to the first and second applications running on the server via a wireless network, the mobile application configured to record details of the promotion agreements and forward same to the second application;
the mobile application being further configured to display the generated unique identifier code for the coupon on the user's mobile application only when the user is within a predefined geographic radius of the retail location associated with the coupon;
the retailer's mobile application being further configured to permit the retailer to scan the unique identifier code on the user's mobile application to record the redemption of the associated coupon and upload the scanned unique identifier code to the second application on the server;
the second application configured to record the scanned unique identifier code and match it to the generated unique identifier code generated for the corresponding coupon and record the redemption of the corresponding coupon when the generated and scanned unique identifier codes match, and
the second application having a payment module configured to send a monetary payment to the promoter from the retailer when the redemption of the coupon is recorded, the amount of the monetary payment being set by the details of the promotion agreement corresponding to the coupon.

2. A system for generating promotional coupons by a promoter, the promotional coupons being redeemable by a plurality of users at a retail location operated by a retailer, the system comprising
a coupon application running on a server, the coupon application configured to record details of a promotion agreement entered into between the promoter and the retailer, the coupon application being further configured to generate a plurality of electronic coupons pursuant to the details of the promotion agreements, said electronic coupons each having a unique identifier code generated by the coupon application;
each of the promoters, retailers and users having a mobile computing device running a mobile application operatively coupled to the coupon application running on the server via a wireless network, the mobile application configured to record the details of the promotion agreement and forward same to the coupon application;
the mobile application being further configured to display the generated unique identifier code for the coupon on the user's mobile application only when the user is within a predefined geographic radius of the retail location associated with the coupon;
the retailer's mobile application being further configured to permit the retailer to scan the unique identifier code on the user's mobile application to record the redemption of the associated coupon and upload the scanned unique identifier code to the coupon application on the server;
the coupon application configured to record the scanned unique identifier code and match it to the generated unique identifier code generated for the corresponding coupon and record the redemption of the corresponding coupon when the generated and scanned unique identifier codes match, and
the coupon application coupled to a payment module configured to send a monetary payment to the promoter from the retailer when the redemption of the coupon is recorded, the amount of the monetary payment being set by the details of the promotion agreement corresponding to the coupon.

3. A system for generating a plurality of electronic coupons which are redeemable by a plurality of users at a retail location operated by a retailer, the electronic coupons being promoted by a promoter, the system comprising:
a coupon application running on a server, the coupon application configured to record details of a promotion agreement entered into between the promoter and the retailer, the coupon application being further configured to generate the plurality of electronic coupons in accordance with the details of the promotion agreement, said electronic coupons each having a unique identifier code generated by the coupon application;
each of the promoters, retailers and users having a mobile computing device running a mobile application operatively coupled to the coupon application running on the server via a wireless network, the mobile application configured to record the details of the promotion agreement and forward same to the coupon application;
the mobile application being further configured to display the generated unique identifier code for the coupon on the user's mobile application only when the user is within a predefined geographic radius of the retail location;
the retailer's mobile application being further configured to scan the unique identifier code on the user's mobile application and upload the scanned unique identifier code to the coupon application;
the coupon application configured to record the scanned unique identifier code and match it to the generated unique identifier code generated for the corresponding coupon and record the corresponding coupon as being redeemed when the generated and scanned unique identifier codes match, and
the coupon application being coupled to a payment module configured to send a monetary payment to the promoter from the retailer when the redemption of the coupon is recorded, the amount of the monetary payment being set by the details of the promotion agreement.

4. The system of claim 2 wherein the promoter's and retailer's mobile application is configured to generate template data entry forms for recording the details of the promotion agreement, the promoter's mobile application being further configured to generate a unique agreement code upon the promoter activating a generate command on the promoter's mobile application, the promoter's mobile application being further configured to transmit the details of the promotion agreement and the unique agreement code to the coupon application, the retailer's mobile application being further configured to scan the unique agreement code from the promoter's mobile application and upload it to the coupon application, the coupon application being configured to record the details of the promotion agreement between the promoter and the retailer by matching the unique agreement codes received from the retailer and the promoter.

5. The system of claim 1 wherein the first application is configured to receive and store geographical tour data from the promoters and display said geographical tour data to users as a plurality of geographic tours, the geographic tours including data concerning the retail locations positioned on or adjacent the geographic tours and the coupons associated with said retail locations, the first application being further configured to transmit the coupons to the user's mobile application.

6. The system of claim 1 wherein the promoters' and retailers' mobile application are configured to generate template data entry forms for recording the details of the promotion agreements, the promoters' mobile application being further configured to generate unique agreement codes upon the promoters activating a generate command on the promoters' mobile application, the promoters' mobile application being further configured to transmit the details of the promotion agreements and the corresponding unique agreement codes to the first application, the retailers' mobile application being further configured to scan the unique agreement code from the promoters' mobile application and upload it to the first application, the first application being configured to record the details of the promotion agreements between the promoters and the retailers by matching the unique agreement codes received from the retailers and the promoters.

7. The system of claim 1 wherein the users' mobile application is further configured to display the unique identifier code when the users activate a redeem coupon function on the mobile application, the users' mobile application being further configured to transmit a redemption notification to the second application on the server when the unique identifier code are displayed, the second application configured to store the redemption notification associated with the unique identifier codes, the second application being further configured to flag the coupon associated with the redemption notification as being suspicious in the event the second application does not match the unique identifier code associated with the redemption notification with a scanned unique identification code for the coupon.
